(19) United States
(12) Patent Application Publication
(10) Pub. No.: US 2011/0162210 A1
(43) Pub. Date: Jul. 7, 2011

(54) Covert saw 'Professional'

(75) Inventor: Richard Holt Poindexter, Rosedale, NY (US)

(73) Assignee: RICHARD H. POINDEXTER

(21) Appl. No.: 12/924,342

(22) Filed: Sep. 24, 2010

Related U.S. Application Data
(60) Provisional application No. 61/272,450, filed on Sep. 24, 2009.

(51) Int. Cl. B23D 21/04; B26D 3/16

(52) U.S. Cl. 30/97; 30/95; 30/123

(57) ABSTRACT

The present invention pertains to an electric-mechanical portably held and operated pipe cutting tool with hidden non-exposed blades that cut a various range and makeup of cylindrical pipe using a duality of synchronized perpetually designed blade motions within a drum shaped compartment which comprises these same blades mounted on a squirrel cage frame of which moves independently and opposite of the blades while sharing the same source of mechanical power.

### RELATED APPLICATION

This invention is related to and claims priority and benefit of U.S. provisional Patent application Ser. No. 61/272,450 filed Sep. 24, 2009, titled Covert Saw ‘Professional’, the inventors being Richard H. Poindexter, and Anthony J. Vola, of which is incorporated herein by reference.

This invention is also related to and claims priority and benefit of Deserted U.S. provisional Patent application Ser. No. 61/213,847 filed Jul. 20, 2009, titled Covert Saw, Richard H. Poindexter, and Anthony J. Vola.

Within provisional patent No. 61/272,450 you see the same utility make-up as provisional patent No. 61/213,847 except for the differences of:
A. Three blades instead of four
B. Reduced gear compartment
C. Change from reciprocal motion of cage to rotation in one direction
D. And as a result of C slight change in braking configuration.
E. Slight change in back side of outer body to trim wasted space.

These changes have direct bearing on the original covert saw being for larger sized pipe, being more rugged and larger in size to compensate for this fact. The reduced version going by the name covert saw ‘professional’ will be substantially easier to manufacture and is more ‘for’ the individual

### FIELD OF INVENTION

The present invention relates to the field of cutting tools or more particularly as portable cutting tools for cutting metal and non-metal cylindrical articles more popularly pronounced as pipe, of assorted sizes and makeup.

### BACKGROUND INFORMATION

Portable electrically driven tools for cutting steel, aluminum, copper, or plastic pipes embodies devices where the user presses a trigger that causes electrical energy to be turned into mechanical energy through use of a small portable motor which interacts with gears, pinions and chains to turn or operate blades designed to cut through metals of assorted nature.

The present field of study involves a wide variety of structural configurations, though certain aspects of all embodiments are basic and similar in construction there remains a wide spectrum of methods and designs. The most popular and basic structure for cutting cylindrical pipes seems to embody the use of rollers mounted on the end of a threaded bolt that incorporates a handle of differing builds on the opposite end of the said rollers and also mounted on said bolt. When the said handle is turned, the threads of said bolt turn inside of a nut that is casted to the main body of said pipe cutter, and a cutting blade is moved incrementally in the direction of the pipe being cut. This blade mounted on said bolt requires force to be applied between it and the tubular body being cut to enable it to force its way through the tubular body thereby severing said tubular body. This method (whether used in conjunction with a motor that turns the pipe or through manual means) see U.S. Pat. No. 1,945,949 R. L. Myers tube cutter Feb. 6, 1934 is by far the most popular amongst inventions defined specifically as pipe cutters even more specifically in the plumbing industry, but generally on the common market, this method is known as the primary means to cutting plumbing pipe.

But even with the many configurations devised to accomplish this same method,—see patents

Floor mounted Machines;
U.S. Pat. No. 1,749,861 W. W. Vosper Mar. 11, 1930, U.S. Pat. No. 2,271,582 W. E. Dixon Feb. 3, 1942,
U.S. Pat. No. 4,807,502 Clifford D. Clark Feb. 28, 1989, U.S. Pat. No. 6,557,227 Shin-Fa Chang May 6, 2003,
U.S. Pat. No. 6,920,812 W. R. Jackson Jul. 26, 2005, U.S. Pat. No. 7,624,663 Lyle D. Kaehr Dec. 1, 2009,
U.S. Pat. No. 7,775,752 Phillip Karow Aug. 17, 2010,

Table top machines;
U.S. Pat. No. 430,552 L. Weinman Jun. 17, 1890, U.S. Pat. No. 1,020,795 B. Borden Mar. 19, 1912,
U.S. Pat. No. 1,115,277 J. T. Bodkin Oct. 27, 1914, U.S. Pat. No. 2,349,499 R. R. Hayden May 23, 1944
U.S. Pat. No. 2,517,355 F. O. Runnels Aug. 1, 1950, U.S. Pat. No. 2,553,147 R. R. Roescheise May 15, 1951,
U.S. Pat. No. 2,619,174 O. A. Neale Nov. 25, 1952, U.S. Pat. No. 3,916,519 Guy T. Gilmore Nov. 4, 1975,
U.S. Pat. No. 4,185,525 C. R. Sherer Jun. 29, 1980, U.S. Pat. No. 4,397,202 Mayfield et. al Aug. 9, 1983,
U.S. Pat. No. 4,776,248 O. J. Birkestrand Oct. 11, 1988 U.S. Pat. No. 5,027,681 Mauno Hyuarinea Jul. 2, 1991,
U.S. Pat. No. 5,243,760 M. R. May Jr. Sep. 14, 1993, U.S. Pat. No. 5,528,830 M. Hansen Jun. 25, 1996,
U.S. Pat. No. 5,920,989 S. L. Taylor Jul. 13, 1999, U.S. Pat. No. 6,131,597 K. Mendicino Oct. 17, 2000,

Tripod Mounted;
U.S. Pat. No. 1,029,265 B. Borden Jun. 11, 1912, U.S. Pat. No. 1,493,452 A Jardine May 6, 1924,
U.S. Pat. No. 2,679,686 C. H. Ingwer Jun. 1, 1954, U.S. Pat. No. 3,839,791 W. C. Feamster Oct. 8, 1974,

Wraps around pipe;
U.S. Pat. No. 103,685 S. P. M. Tasker May 31, 1870, U.S. Pat. No. 554,028 J. N. Marso Feb. 4, 1896,
U.S. Pat. No. 722,843 W. Hopflinger Mar. 17,1903 U.S. Pat. No. 2,373,472 C. Haumiller Apr. 10, 1945,
U.S. Pat. No. 2,448,578 E. E. Condon Sep. 7, 1948, U.S. Pat. No. 2,567,833 C. E. Warren Sep. 11, 1951,
U.S. Pat. No. 2,983,043 T. Petersen May 9, 1961, U.S. Pat. No. 3,431,646 J. L. Young Mar. 11, 1969,
U.S. Pat. No. 4,347,664 Frank T. Yost Sep. 7, 1982, U.S. Pat. No. 4,493,150 Carlos M. Garcia Jan. 15, 1985,
U.S. Pat. No. 4,624,052 Carlos M. Garcia Nov. 25, 1986,

Mounted on Pipe being cut;
U.S. Pat. No. 445,138 W. H. Garland Jan. 20, 1891, U.S. Pat. No. 1,394,781 I. W. Nonneman Oct. 25, 1921,
U.S. Pat. No. 1,715,921 E. E. Himes Jun. 4, 1929, U.S. Pat. No. 1,932,462 R. W. Howlett Oct. 31, 1933,
U.S. Pat. No. 1,985,541 H. P. Hoefer Dec. 25, 1934, U.S. Pat. No. 2,162,210 H. D. Alston Jun. 13, 1939,
U.S. Pat. No. 2,212,564 P. E. Hord Aug. 27, 1940, U.S. Pat. No. 2,291,395 C. J. Levey Jul. 28, 1947,
U.S. Pat. No. 2,561,484 A. W. Shaw Jul. 24, 1951, U.S. Pat. No. 3,001,283 M. W. Woods Sep. 26, 1961,
U.S. Pat. No. 3,168,002 P. D. Walling Feb. 2, 1965, U.S. Pat. No. 4,149,312 Alfred R. E. Arnot Apr. 17, 1979,
U.S. Pat. No. 4,418,591 William H. Astle Dec. 6, 1983, U.S. Pat. No. 4,490,909 Edward H. Wachs Jan. 1, 1985,
U.S. Pat. No. 4,531,288 Claude Aubrioy Jul. 30, 1985, U.S. Pat. No. 5,081,768 Mathew T. Brennen Jan. 21, 1992,
U.S. Pat. No. 5,349,751 Markus Fahr Sep. 27, 1994, U.S. Pat. No. 6,267,037 W. McCoy Jr. Jul. 31, 2001,

Hand held Manual;
U.S. Pat. No. 136,004 A. J. Pennock Feb. 18, 1873, U.S. Pat. No. 184,652 G. Moller Nov. 21, 1876,
U.S. Pat. No. 377,725 G. G. Thompson Feb. 7, 1888, U.S. Pat. No. 415,714 J. Hammerand Nov. 26, 1889,
U.S. Pat. No. 479,892 J. F. Mason Aug. 2, 1892, U.S. Pat. No. 547,615 J. J. O'Donohue Oct. 8, 1895,
U.S. Pat. No. 824,764 W. S. Wakeley Jul. 3, 1906) U.S. Pat. No. 1,130,395 M. L. Gilmour Mar. 2, 1915,
U.S. Pat. No. 4,224,737 Jim R. Hart Sep. 30, 1980, U.S. Pat. No. 4,416,062 John R. Cummings Nov. 22, 1983,
U.S. Pat. No. 4,446,620 Karl-Heinz May 8, 1984,

The most popular tools on the general market actually used by tradesmen to cut pipe outside of the field of plumbing is the saw zaw, U.S. Pat. No. 7,363,713 Reciprocating power tool Hirabayashi et al. Apr. 29, 2008 and the portable band saw, Pat. no. 2009/2065943 Philip T. Miller Oct. 29, 2009 and Pat. No. US 2007/0068011 Shibata et al. Mar. 29, 2007 Each of these are in a different specific class and non-related to the specific field of pipe cutters, presently spoken of. These two methods embody entirely different concepts of structure and use though they can also cut pipe, and are used to do so. These two methods, not specifically defined as pipe cutters but generally as saws for cutting metal, serve the entire pipe cutting market outside of plumbing. If some of the above mentioned and heretofore mentioned patents, used as reference, of the same class of pipe cutters have been manufactured, they exist and are used on the industrial level and are not on the common market for use by common tradesmen where the actual installation of cut pipes occurs. Out of all the tools mentioned one such tool recently did hit the market about two years ago similar to Pat. No. Des. 329,793 Kenji Fukuda Sep. 29, 1992 using the traditional blunt pressure method for half inch O.D. pipe

The obvious reasons why these great ideas are not on today's market are confined within several reasons.
1. there too expensive to market, except for use on the industrial level
2. they are not marketable
3. they are not practical in build, too bulky, unattractive or awkward
4. they don't work well
5. the method using pressure applied to a blade onto the pipe being cut is a difficult conversion to make from the more typical long standing manual version to an electrical version of the same.

The method using pressure applied to a blade onto the pipe being cut was a great idea when made manually, but when converted to an electrical version, because of the torque required to cut through the pipe by the blade, along with the torque required to turn the pipe at the same time, or also, the effort required in just simply holding the pipe stationary as this torque is applied is difficult, and costly. Usually to accomplish these task you need a rather bulky machine or vise in operation, taking it out of the realm of being a portable hand held tool. But even with this these machines labor to cut stock such as rigid steel pipes.

The portable band saw of which commonly uses a blade in a band shape for which revolves around cylindrical wheels rotating in the same direction, where the blade has punched teeth that force there way through metal surfaces using torque motors and leverage. The principles of the saw-zaw contrarily uses a streamlined blade attached to an arm which reciprocates back and forth using speed and traditional sawing action to eat away at a metal surface along with using leverage to force itself through.

In both cases you have an environment where the blade is exposed to the user who has to be extremely careful while handling the tool. The danger of an exposed blade is constant, real, and continuous for every time the handler pulls the trigger to induce the mechanical power. The operator has to be conscious even when there is nothing being cut; that when the trigger is pulled after disengaging any safety buttons he has to be conscious of the whereabouts and position of the blade with relation to his own body parts. In addition; factors such as binding, shifting, blade angle, unintentional or not can cause sudden jerking which can be very ominous to the most experienced and cautious users even with the implementation of guards. The tool could also experience blade breakage, which can send a sharp metal object flying past the users face or in a worse case scenario direct contact with the blade can occur.

Here are some other pipe cutters more closely related to the present invention than those mentioned above as portable power tools to be used by tradesmen, incorporating both d.c. and a.c. power sources to turn pinions and gears to power assorted blade types through the metal being cut, in order to dismember the metal and non metal cylindrical bodies;

Heavy duty portable power tool with an outer casing
U.S. Pat. No. 2,195,568 A. M. Hexdall Apr. 2, 1940 U.S. Pat. No. 2,769,235 A. E. Martois Nov. 6, 1956,
U.S. Pat. No. 3,370,352 B. E. Steely Feb. 27, 1968 U.S. Pat. No. 3,974,562 Xaver Wiichner Aug. 17, 1976,
U.S. Pat. No. 4,492,136 Ronald I. Walker Jan. 8, 1985 U.S. Pat. No. 4,769,911 Masahary Araki Sep. 13, 1988,
U.S. Pat. No. 4,953,292 Billy D. Tobey Sep. 4, 1990 U.S. Pat. No. 5,103,699 Apr. 14, 1992,
Des. 325,504 B. D. Tobey Apr. 21,1992 U.S. Pat. No. 5,142,825 Kenneth R. Floyd Sep. 1, 1992,
Des. 329,793 Kenji Fukuda Sep. 29, 1992 U.S. Pat. No. 5,261,301 Larry F. Babb Nov. 16, 1993,
U.S. Pat. No. 5,829,142 John Rieser Nov. 3, 1998 U.S. Pat. No. 5,836,079 Michael E. Cronin Nov. 17, 1998,
U.S. Pat. No. 5,943,778 Micheal A. Alana Aug. 31, 1999 U.S. Pat. No. 6,014,810 Kent L. Earle
U.S. Pat. No. 6,079,302 G. F. Gudleske Jun. 27, 2000 U.S. Pat. No. 6,129,488 Markus Fahr Oct. 10, 2000,
U.S. Pat. No. 6,189,216 Dan R. Duranko Feb. 20, 2001 U.S. Pat. No. 6,257,110 Donato L. Ricci Jul. 10, 2001,
U.S. Pat. No. 6,336,270 Dan R. Dureiko Jan. 8, 2002 U.S. Pat. No. 6,553,669 Sam W. Carter Apr. 29, 2003,
U.S. Pat. No. 6,568,086 Herbert Kramer May 27, 2003 U.S. Pat. No. 6,941,660 Leo Varus Sep. 13, 2005,
US2005/0274023 Dec. 15, 2005 U.S. Pat. No. 7,152,325 Carroll D. Green Dec. 26, 2006,
US2007/0050984 Bartoluzzi Mar. 8, 2007 U.S. Pat. No. 7,174,638 Stephan Singer Dec. 13, 2007, *D568,701S Nasiell May 13, 2008 U.S. Pat. No. 7,464,472 Timo Kargas Dec. 16, 2008
U.S. Pat. No. 7,743,510 M. Lazarevic Jun. 29, 2010, US2009/0199407 Lazarevic Aug. 13, 2009
US2010/0088898 Thorson Apr. 15, 2010

Special mechanical electric/mechanical methods;
U.S. Pat. No. 514,577 J. B. Waring Feb. 13, 1894 U.S. Pat. No. 638,065 J. J. Rigney Nov. 28, 1899
U.S. Pat. No. 760,128 R. A. Jackson May 17, 1904 U.S. Pat. No. 1,301,759 R. P. Stewart Apr. 22, 1919
U.S. Pat. No. 1,393,156 I. W. Nonneman Oct. 11, 1921 U.S. Pat. No. 2,097,358 H. C. Whittaker Oct. 26, 1937,
U.S. Pat. No. 2,112,396 R. J. Corrigan Mar. 29, 1938 U.S. Pat. No. 2,672,682 A. W. Studebaker Mar. 23, 1954,
U.S. Pat. No. 2,699,604 C. H. Ingwer Jan. 18, 1955, *U.S. Pat. No. 2,842,238 A. W. Shaw Jul. 8, 1958
U.S. Pat. No. 3,088,352 H. Tanner May 7, 1963 U.S. Pat. No. 3,807,047 C. Richard Sherer Apr. 30, 1974,
U.S. Pat. No. 3,942,248 Richard Sherer Mar. 9, 1976 U.S. Pat. No. 4,359,820 L. H. Wheeler Nov. 23, 1982,
*U.S. Pat. No. 4,402,136 Wlodzimierz Rast Sep. 6, 1983 U.S. Pat. No. 5,394,776 Jerry H. Robinson Mar. 7, 1995
U.S. Pat. No. 7,013,567 Kent J. Myers Mar. 21, 2006 US2008/0229584 F. Shepherd Sep. 28, 2008

Portable electric;
U.S. Pat. No. 1,691,763 E. C. Kastner Nov. 13, 1928 Des. 378,340 D. L. Harter Mar. 11, 1997
U.S. Pat. No. 3,946,487 Zdrislaw Bieganski March 30 U.S. Pat. No. 4,802,278 Vanderpool Feb. 7, 1989, 1976
U.S. Pat. No. 5,088,196 Kenji Fukuda Feb. 18, 1992 U.S. Pat. No. 5,301,427 Elizabeth Swatek Apr. 12, 1994
U.S. Pat. No. 6,065,212 Milisau Lazarevic May 23, 2000 U.S. Pat. No. 6,202,307 Leonard Wrate Mar. 20, 2001
U.S. Pat. No. 6,430,815 G. R. Wickline Aug. 13, 2002 U.S. Pat. No. 6,560,880 Kazua Itoh May 13, 2003
US2003/0121156 R. Walsh Jul. 3, 2003 U.S. Pat. No. 6,637,115 Richard Walsh Oct. 28, 2003
U.S. Pat. No. 6,698,048 R. T. Greene Mar. 2, 2004, U.S. Pat. No. 7,159,319 Wu Sheng Huang Jan. 9, 2007
US2007/0180701 Heinz Hut Aug. 9, 2007 U.S. Pat. No. 7,406,769 Richard Toussaint Aug. 5, 2008
U.S. Pat. No. 7,434,319 Chen Lin Tsai Lian Oct. 14, 2008

While cutting, it is a requirement that users wear goggles, this is very important and we suggest that this continue even with usage of tools such as the covert saw. While cutting pipe with traditional saws very hot debris and shavings fly past the users face and under these conditions goggles are preferable and necessary. It is common though that 75 percent of users do not wear goggles even at severe risk of losing an eye or even mortality.

Within different trades there is a need to cut pipe straight. Tradesmen with more experience learn with time how to do this. For the most part if you take a look at most cuts, they are more usually than not crooked or jagged especially when the cut is done by inexperienced users.

Under most circumstances it would be advantageous to prevent blade wear of which happens most often through just normal wear and also heating effects on blade material. Heating effects are lessened when the blade is in motion. Less force has to be applied to get the blade to cut faster, and this also lessons wear to increase blade life. However as mentioned earlier when the blade is moved by the operator there are dangers involved with binding, breakage of blade, and a host of unpredictable turns of events involved with operator error, inherent to happen, and does, at very not surprisingly short intervals.

With this you have two very conflicting circumstances. To cut faster and make the blade last longer by lessening the heating effects you have to move the saw around; yet because of the potential threat of injury it is very dangerous to do so. The operator has the choice of chancing serious injury by moving saw around, or being more careful, but spending more money in purchasing blades that burn out at unnecessary rates. Most users work for someone else and are unaware of these facts; they impatiently just want to get the job done faster so they use force to speed things along not being concerned actually if someone else has to pay for the blades. But they constantly put themselves at risk of injury because of this impatience.

As you can see there are various forms of pipe cutters including some of the general structural and operational features of the present invention heretofore have been provided such as those disclosed in paragraph [0020]-[0022]. However, these previous known forms of pipe cutting devices do not include the overall combination of structural features incorporated in the present invention.

### SUMMARY OF INVENTION

The object of this invention is to solve the aforementioned problem where the user does not have to physically move the saw around to lessen heating effects detrimental to blade life because the blade motions and the separate cage motion in the opposite direction of the saw blades does this for him.

It is also the object of this invention to create a safer environment by taking more control of cutting by providing the motion to do so in order to lessen or reduce operator control and error in providing more precision movement necessary to prevent binding, and kick back which happens through application of uneven force applied by user. This would lessen the rate of injury inherent in all fields where pipe has to be cut and installed.

It is even further the object of this invention to provide an over all housing in which the cutting is done so the dangers inherent in an open environment where flying projectiles, chips, hot shavings, and the blade itself cannot reach vulnerable places on the users body where it can cause damage.

It is also the object of this invention in not assuming to replace the necessity of goggles or to make people use them, but to provide a viable source of assistance in at least keeping down injury for the majority who do not use them by providing a housing with within cuts are made to eliminate the possibility altogether.

And further the object of this invention is to introduce a new and unique method of cutting pipe where any operator whether inexperienced or not can use this tool to make straight accurate, precision cuts on pipe.

It is further the object of this invention to provide an easy to build, working, usable pipe cutting saw that is convenient, economical, light weight, easy to use, and marketable by today's standard's because of the safety aspect, the fast action in the cuts and the attractiveness within the saw build.

Another object of this invention is to provide an alternate means to cutting assorted sizes and material makeup of pipes than the typical method incorporating rollers and blades utilizing pressure between a blade and a pipe being cut using substantial pressure therewith to force a blunt blade through a pipe

It is also the object of the present invention to provide a saw with a motor drive means, and assortment of gears and pinions that has two sets which can operate in opposite directions from, each other to turn two planetary beveled gears that rotate in opposite directions from each other. One planetary beveled gear 12 with the teeth on the side can be attached directly to a cage 44 mounted on wheels 60 and housed inside of a cutting drum 62 to turn said cage 44 in one direction with cutting blade bodies 1 mounted on said cage 44 to revolve around said cage 44 when said motor 72 drive 70 is engaged. On the opposite side of said cage 44 you can have the second beveled planetary gear 45 with said second beveled planetary gear 45 being bolted to a planetary inside gear 47 or a planetary solid chain 47, both of which is floating where the inside gear 47 or chain 47 portion has two flanges 49 on each side to hold said planetary inside gear 47 or planetary solid chain 47 in place on top of spur gears 22 or sprockets 22 with said spur gears 22 or sprockets 22 supporting the planetary inside gear 47 or solid chain 47 that is bolted to the said planetary beveled gear 45.

It is also the object of the present invention to provide a process by which the said planetary inside gear 47 or planetary solid chain 47 is engaged by a beveled gear 65 driven by said motor 72 through pinions and spur gears 70, 67 in the opposite direction as the said beveled planetary gear 12 attached directly to said cage 44. This floating gear 45, 47 being made up of the planetary beveled gear 45 that is bolted to a planetary inside gear 47 or solid chain 47 with flanges 49 on the sides that is bolted thereupon, turned by a beveled gear 65 mounted on a shaft works to power said spur gears 22 or sprockets 22 that are attached to a shaft 65 going through the cage cross brace member 78, FIGS. 2, 3, 21 and is attached to a spur gear 4 or sprocket 4 that is attached to the end of said shaft 18 leading into the inner blade body 1.

It is also the object of this invention to provide a means of support for the pipe being cut through a jaw assembly 53 mounted independently to the inside of the saw body 16 on a donut shaped plate 64 FIG. 19 for shifting along the aforementioned diametric plane between extended and retracted positions and are disposed immediately outward of the outer periphery of the periphery of the circular blades 20 and open radially outward therefrom along the aforementioned diametric plane when in the extended positions.

It is also the object of this invention to provide a means where the blade housings 1 consisting of inner spur gears 4, 6 or sprockets 4, 6 FIG. 3, inner belts 8 or chains 8 is mounted to said cage cross member 18 and can pivot on its own diametric axis both toward and away from the pipe being cut this action being controlled by an assembly of spur gears 88, 89 a pad 87 mounted to the outer handle 38 where said handle 38 can adjust to different pipe sizes written out on the top of the outer saw body 16 under the said outer handle 38. Where the said pad 87 can be lowered into place by use of a button 99 on the said handle 38 that releases a ball pen tab 29 FIG. 5 where the pad 87 can be lowered onto two spur gears 88, 89 with the pad 87 being spring biased upward once released from the ball pen tab 29. The two spur gears 88, 89 will be supported by an extrusion 93 casted to the same housing that supports the pad 94. The two spur gears 88, 89 will turn a planetary gear 81 with the teeth on the outer surface this planetary gear 81 will be bolted to another planetary inside gear 80 with flanges 83 on the side similar to the planetary inside gear 47 on the opposite side with flanges 49.

This planetary inside gear 80 with flanges 83 will float on top of spur gears 85 that are attached to the cage cross member 18 so that when said pad 87 is released by the said ball pen tabs 29 and is pushed forward or back this action will work to turn the floating planetary inside gear 80 and adjust the blade housings 1 that are on their own diametrical axis toward and away from the pipe being cut. This planetary inside gear 80 will also incorporate a brake pad locking device 96 set on springs 98 that keep the planetary inside gear 80 biased toward being locked in rotation with the cage cross member 18 unless the ball pen tab 29 is released and the handle 38 is pushed down releasing the locking device 96 which acts as a brake pad 96 to adjust the axis of the blades 1 towards or away from the pipe being cut.

It is the object of this invention to provide an alternate and a more simple embodiment eliminating the additional gear and brake section for lowering the blade housings 1 by placing the outer handle 38 on a pivot with a pad 7 on the opposite end of the handle 38 to contact the top surface of the planetary inside gear 80 or sprocket 80 eliminating the planetary outside gear 81 and providing a smooth surface on the outer side of the planetary inside gear 80 to be contacted by the 7 pad on the opposite end of the outer handle 38 that is on a pivot so that when the user pull back on the top handle 38 the pad 7 will pivot on an axis towards the smooth outer surface braking the rotating cage 44 by means of this contact to the floating inside gear 80 slightly forcing the individual blades 1 into the pipe being cut being controlled by the pressure applied by the user by pulling back on the outer handle 38.

It is also the object of the present invention to provide more cutting power to the cutting blades 1 by rotating the cage 44 in the opposite direction of the rotating axis of the individual blades 1.

### BRIEF DESCRIPTION OF THE DRAWINGS

FIG. 1 is an elevation view of the inside of the covert saw.

FIG. 2 gives you a plan view of the cutting compartment inside saw.

FIG. 3 offers a blown up front elevation view of blade housing and gears that drive and control the operation of the blade.

In FIG. 4 you see an exterior plan view of the top of the saw.

In FIG. 5 offers you a blown up perspective view of the top handle, the blade adjust and braking section.

FIG. 6 gives you a diagrammatic elevation view of the exterior of the saw with the blades being exposed.

In FIG. 7 you gain a perspective cutaway of the inner drum of the cutting compartment with a slight glimpse of the cage and gears.

FIG. 8 gives you a perspective cut away view of the cage of which supports the blades.

In FIG. 9 you see a blown up elevation cut away view of one cutting blade.

With FIG. 10 you get a blown up perspective view of the high-tension spring.

FIG. 11 gives you a blown up perspective section view of the secondary blade gear.

FIG. 12 is a slightly blown up front elevation cut away of the vise dress.

FIG. 13 is a slightly blown up perspective cut away of the vise boot.

FIG. 14 is a slightly blown up elevation cut away of a gear attachment on the vise.

FIG. 15 is a blown up side plan view of the alternate embodiment of which the entire brake section is eliminated and replaced with a pad on a swivel configuration that causes a pad to directly contact the top of the planetary gear in order to lower the blades onto the pipe thereby creating the necessary pressure from the blade onto the pipe by manual means without the excess gears in the braking section.

FIG. 16 offers a blown up perspective section view of a piece of the brake system.

FIG. 17 gives you a blown up sectional perspective look at one of the planetary gears within the saw.

In FIG. 18 you see a blown up section elevation cut away view of the brake.

In FIG. 19 gives you a elevation view of the plate supporting the jaw assembly.

In FIG. 20 you get a blown up elevation cut away of a planetary gear.

FIG. 21 gives you a blown up elevation view of a spacer placed between the blade housing and the cage.

### DETAILED DESCRIPTION OF INVENTION

The present invention will now be described in a more detailed manner with reference to the accompanying drawings in which embodiments of the invention are shown. Notwithstanding the drawings and following explanations are to be understood instructively and are intended to ensure that the idea of the invention is thoroughly understood. By contrast these exemplary embodiments are not intended to be used to restrict the invention which will be defined solely in the claims and which discloses to the person skilled in the relevant art a markedly wider range of embodiments than can be illustrated within this framework.

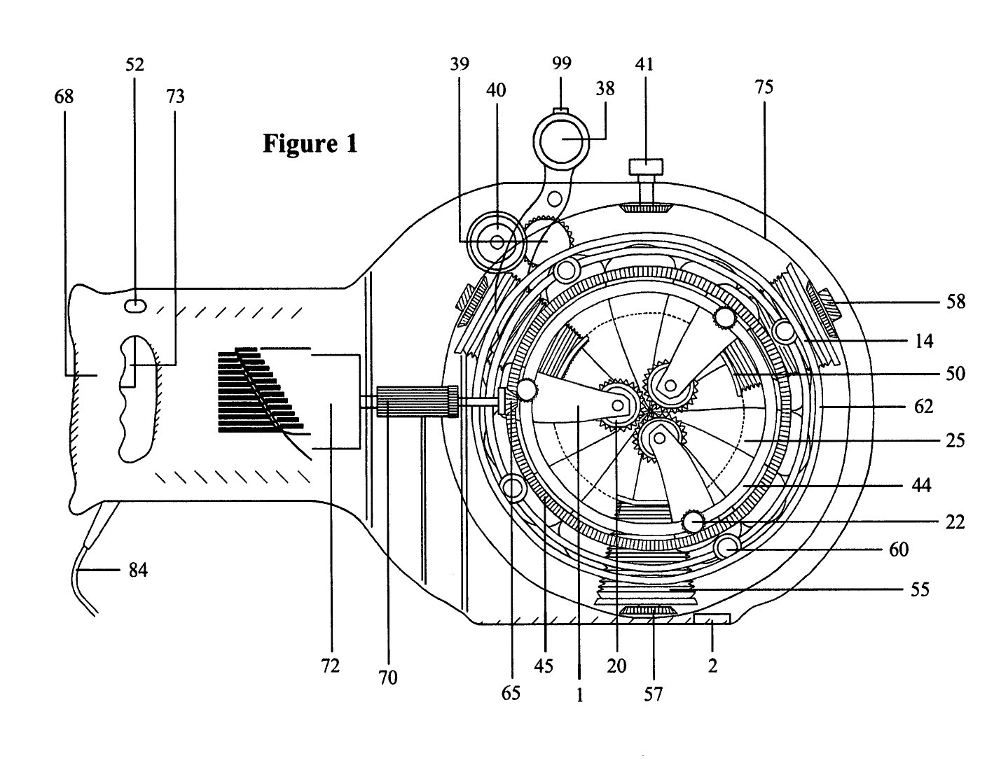

Within FIG. 1 you see the overall shape of the saw with a glance at the inner parts of it, where you see the handle 68 that embodies a trigger 73 and a trigger release 52. Just underneath the handle you see the cord 84. Inside the saw you see a representation of a motor 72, which is a 120v. Single phase, and typical of most portable tool motors requiring high RPM speed with capability to withstand typical occasional torque conditions encountered with portable tool use.

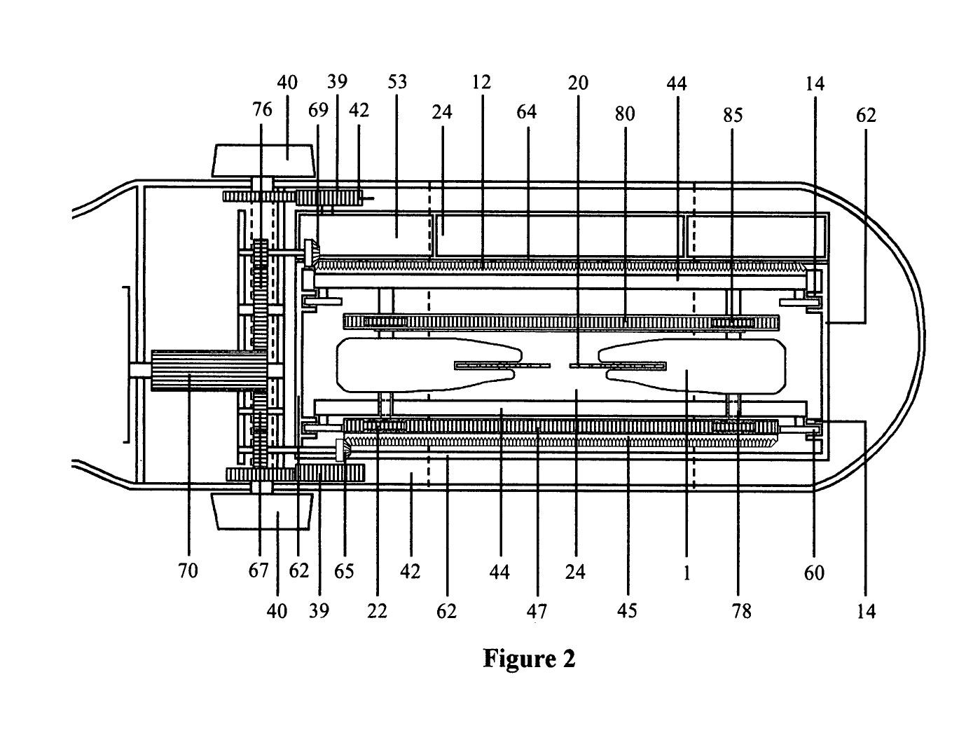

On the motor shaft you have a pinion 70 which drives two spur gears on a rod with the opposite end of the rod consisting of a spur gear 67 for powering blades 1 going in one direction, and 76 FIG. 2 for powering rotation of cage 44 going in the opposite direction of the blades 1.

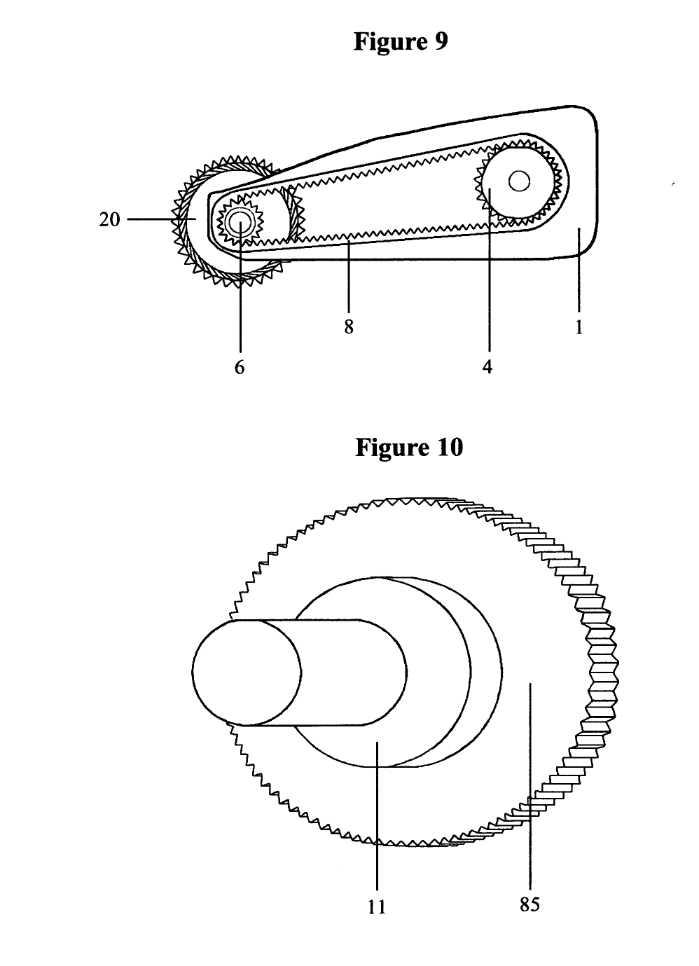

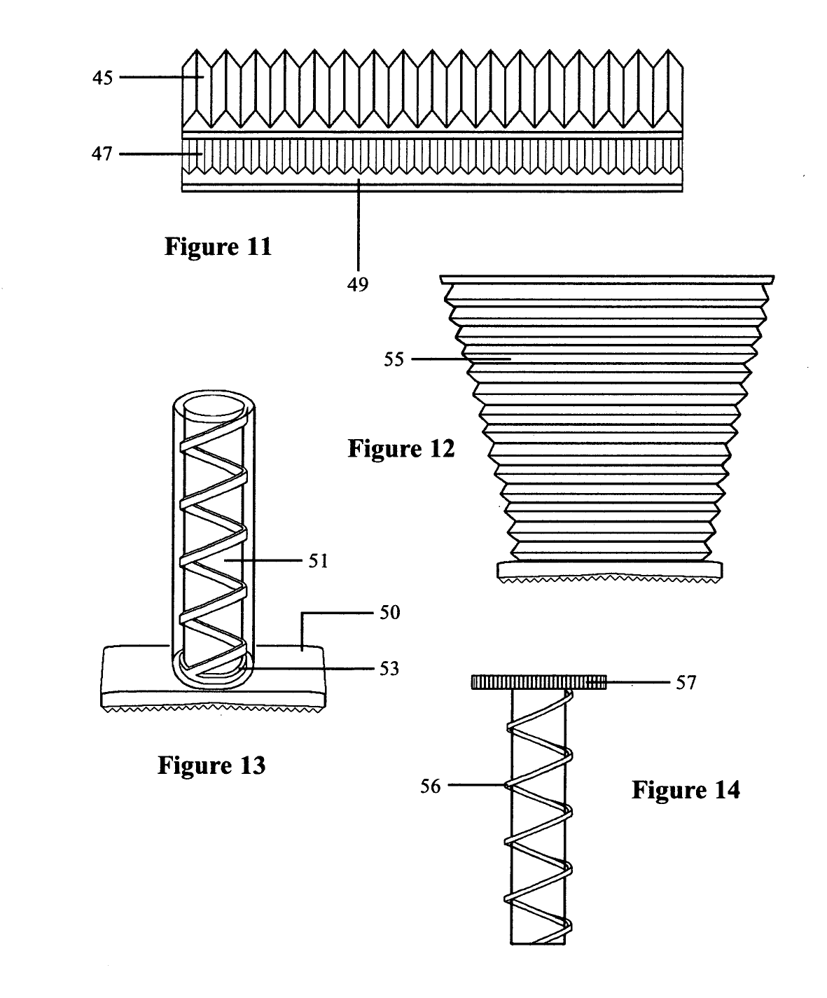

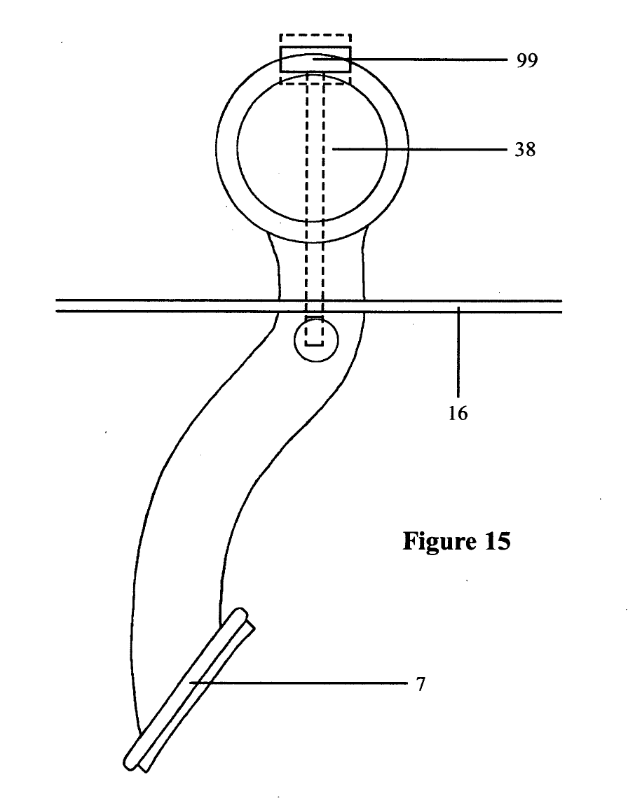

Both gears 67 and 76 FIG. 2 moving in opposite directions power two other bevel gears 65 and 69 on an extension pole FIG. 2, attached to rods with bevel gears 65 and 69 one going through the blade drum wall 62 and contacting two planetary gears—12 FIG. 2 which is bolted directly to the cage 44 and powered by a bevel gear 69. The other planetary gear 45 is made up of two separate gear faces with teeth on the inner surface of ring with flanges covering and beveled teeth in addition on the side surface, this can be two separate gears bolted to each other also see FIG. 11. The planetary gear 45 is driven by a planetary beveled gear 69 FIG. 2, and gear 45 is a ‘floating’ gear whose purpose is to drive blades 1.

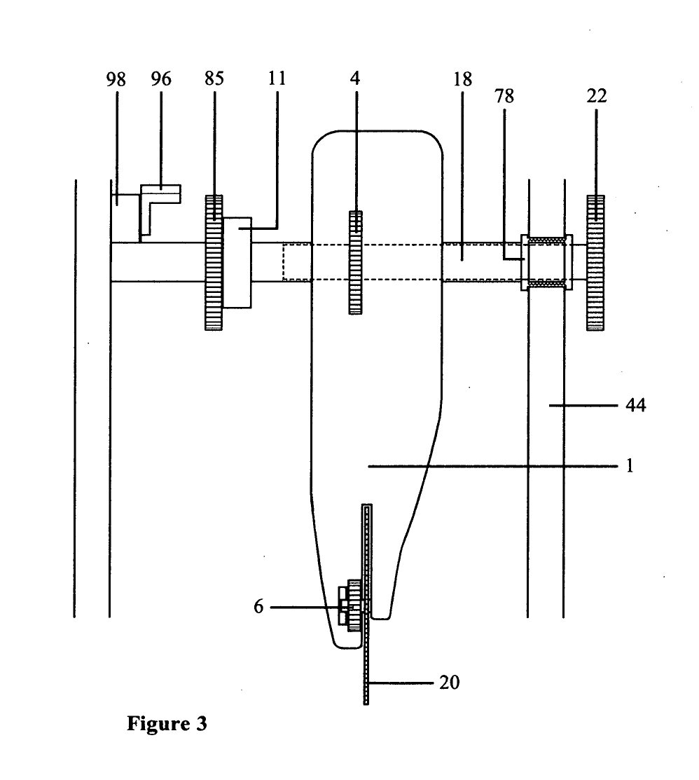

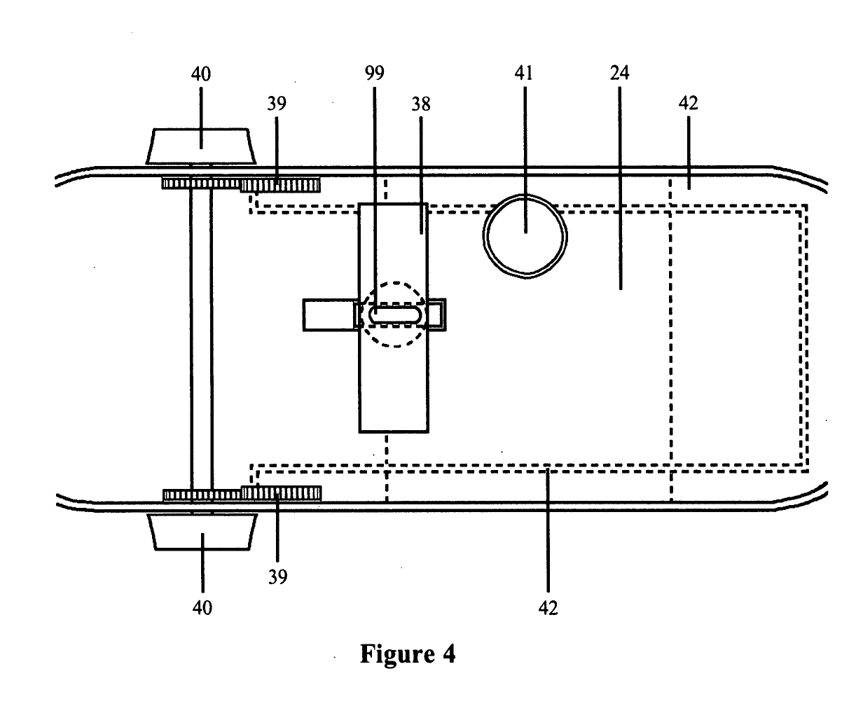

The planetary gear 45 is resting directly on top of three spur gears or sprockets 22 (In the professional version) of which they act to support the planetary gear 45 because of the flanges 49 on the sides of the inner teeth of the gear 45. The spur gears or sprockets 22 are attached to an extension arm that pass through the cage 44 and into the blade housings 1 where another gear 4 or sprocket 4 FIG. 3 is attached to the opposite end of the extension pole within blade housing 1.

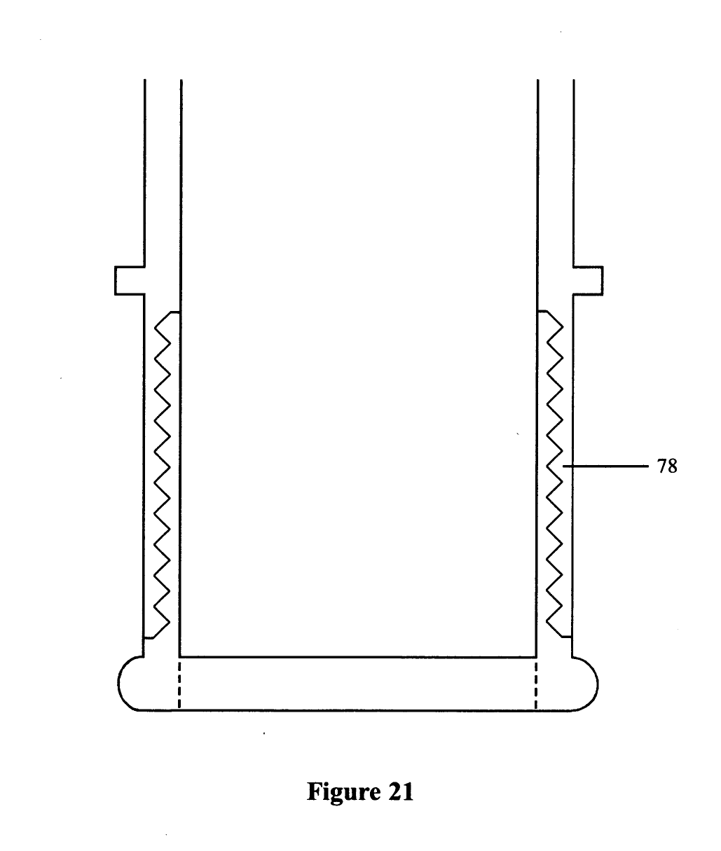

FIG. 9 gives us a full perspective view of the cage 44. The function of the cage 44 is to support three cutting blades 1 which are mounted on the cross members 18 of the cage 44. The cross members 18 are not permanently cast to the cage 44 but attached through bolts which enables them to pivot. The blades 1 on the other hand is cast to one side of the cross members 18 with other side being comprised of a short spacer 78 FIG. 2, FIG. 3, and FIG. 21.

The cage 44 has two tiers, inner and outer. The inner tier is comprised of the cross members 18 and blades 1, and the outer tier has the wheels 60 attached, also see FIG. 1 and FIG. 2. These wheels are bolted to the cage 44 and are aligned to tracks 14 cast into the drum housing 62 also see FIG. 7, FIG. 1. As pinion gear 69 drives the first planetary beveled gear 12 which is bolted to the cage 44, the cage 44 turns all the way around 360 degrees and continues to do so as long as the trigger 73 is pulled and the brake 3 FIG. 2, FIG. 5, FIG. 18, is engaged.

FIG. 7 depicts the blade drum housing 62 of which is cast as part of the inner mold of the saw body 16 except for one side that can be removed by screws. The blade drum 62 houses the cage 44 and for the purposes of this document it will also be referred to as the cutting compartment 62. This compartment as a whole has a donut shape with openings to allow it to accommodate the insertion of pipe. There are also openings on the top and back for operational functions such as, adjusting jaw and curtains and also braking in two separate embodiments. There is a trap door opening on the bottom 2 FIG. 1 to eliminate build up of debris.

FIG. 9 gives us a glimpse inside of the individual blade housings 1. We see the blade itself 20, which is small, and cylindrical with very small, serrated teeth made to cut through steel. There is a gear or sprocket 6 attached to the blade 1 that is driven by a chain or belt 8. On the other end of the chain or belt 8 there is another spur gear or sprocket 4 which is adhered to a rod which leads outside of the blade body 1, FIG. 3 through a spacer 78 and the cage 44 and then attached the spur gear 22 being driven by the second planetary inside gear or planetary solid chain 45 FIG. 1, FIG. 2.

In FIG. 5 you get a look at the configuration of gears and supports of which acts to:
1. Lower blades 1 into place
2. Keep them lowered in place
3. Raise blades 1 after cutting cycle is over.

Please keep in mind that we are dealing with a system of parts that move. The cage 44 rotates around carrying the blades 1, which rotate in the opposite direction giving a dragging effect. So to lower blades 1 into place we have a system that will attach itself to the cage 44 and blades 1, execute its function and then separate itself and remain separated from the moving parts.

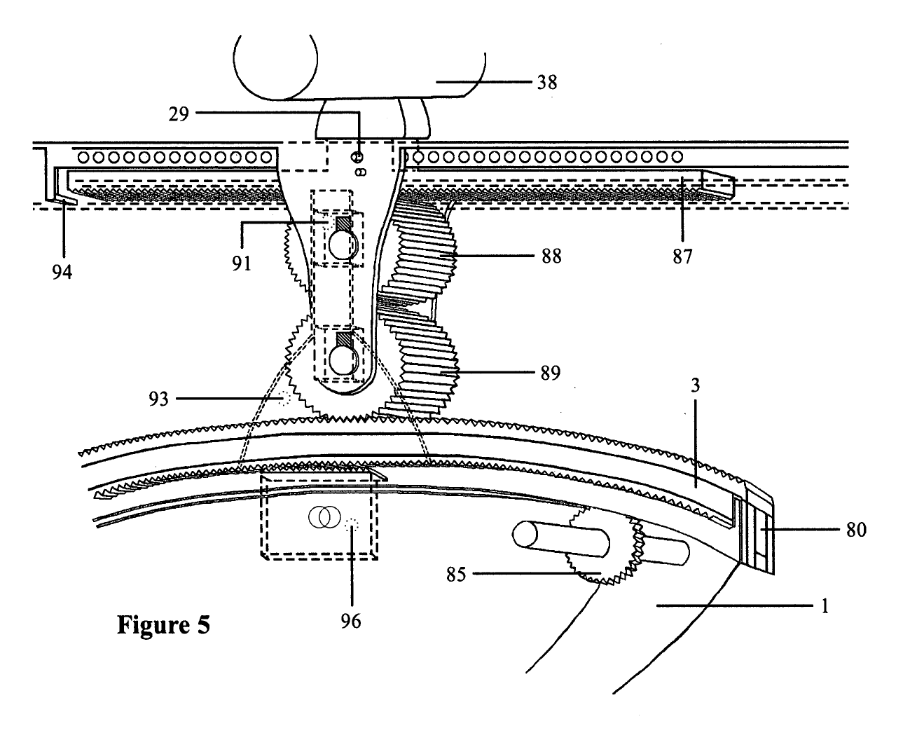

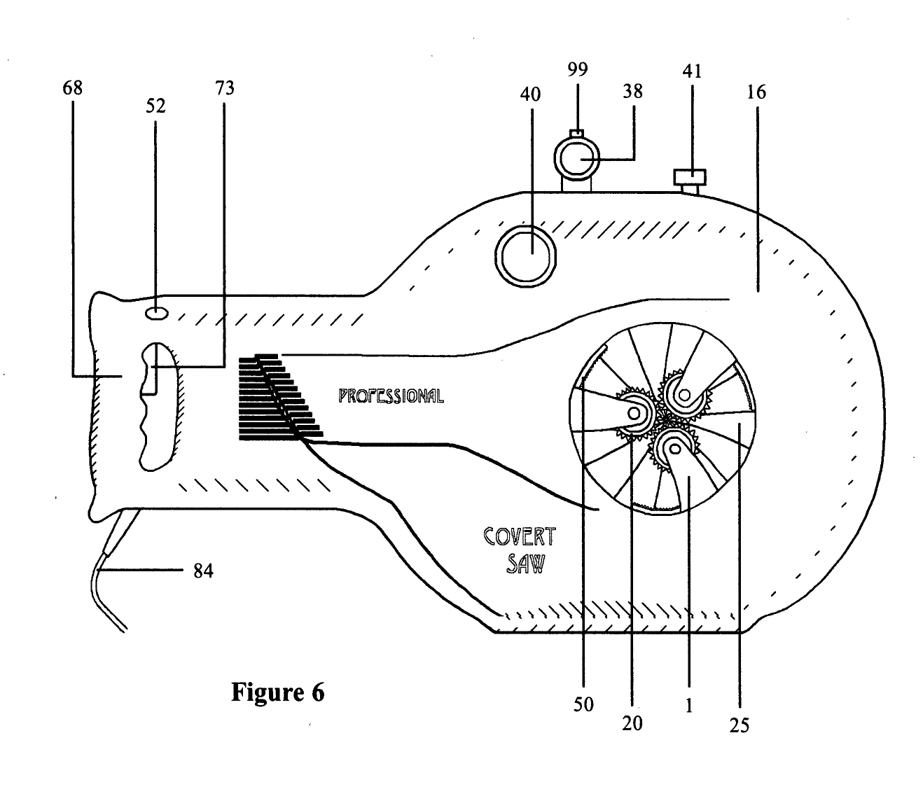

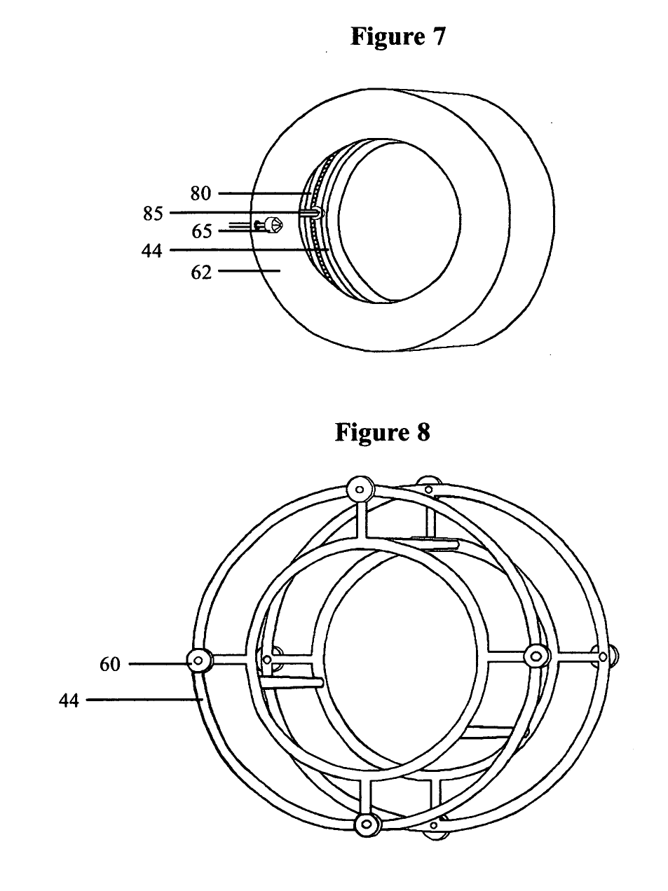

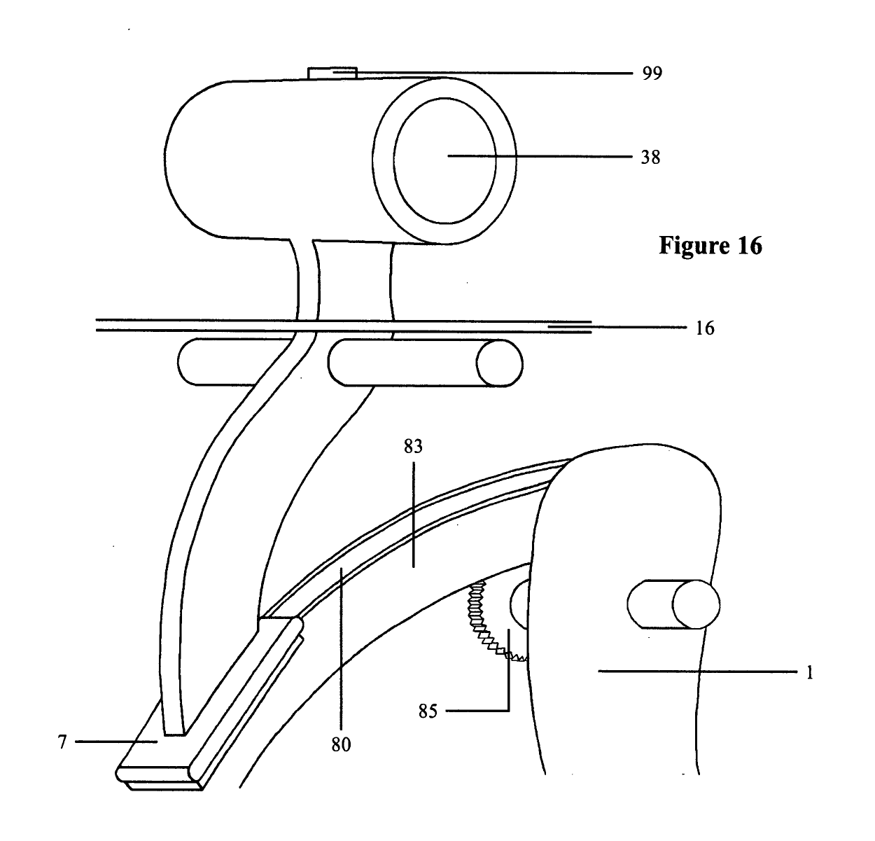

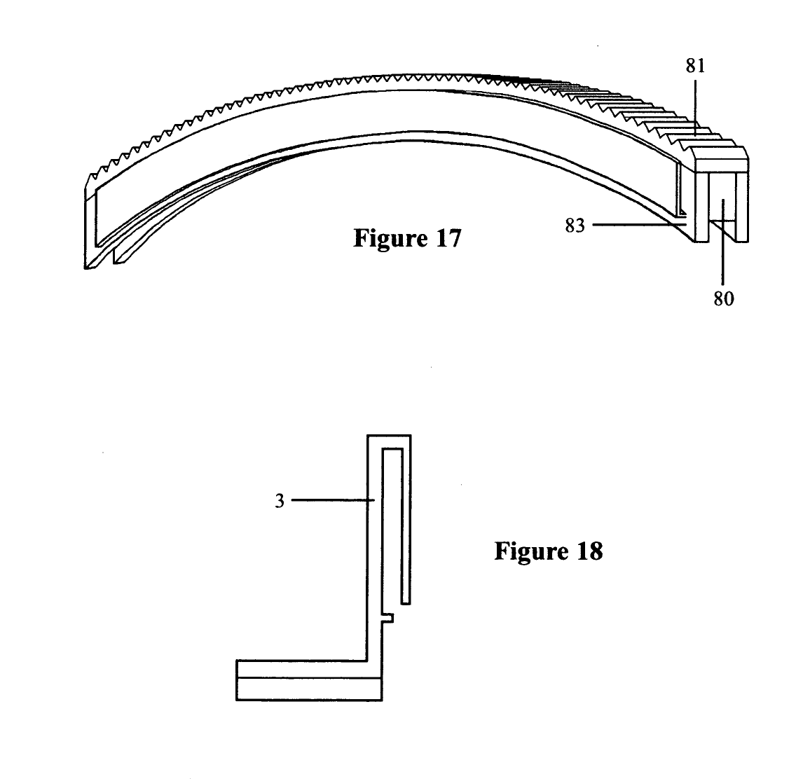

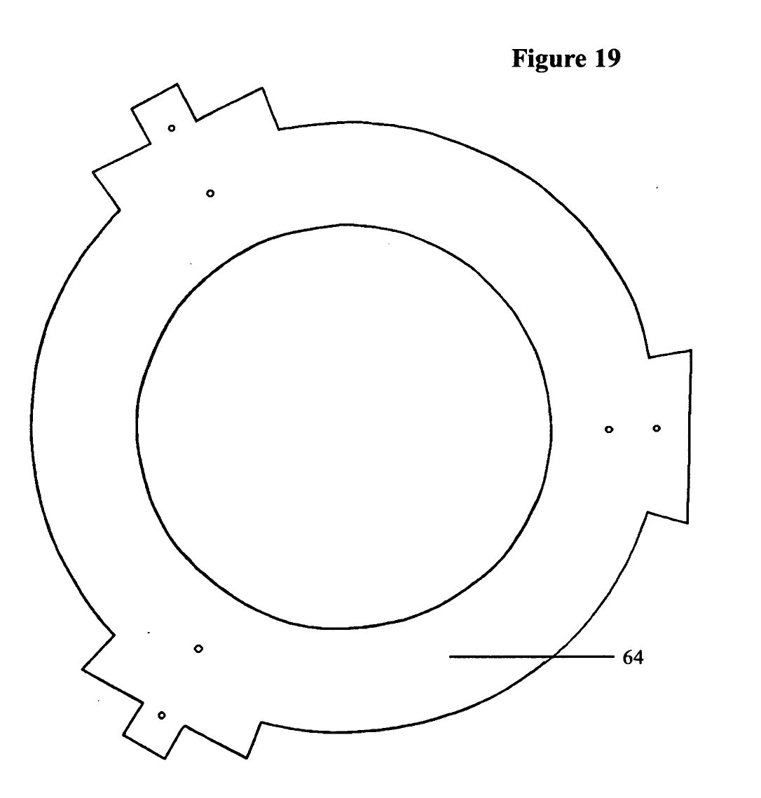

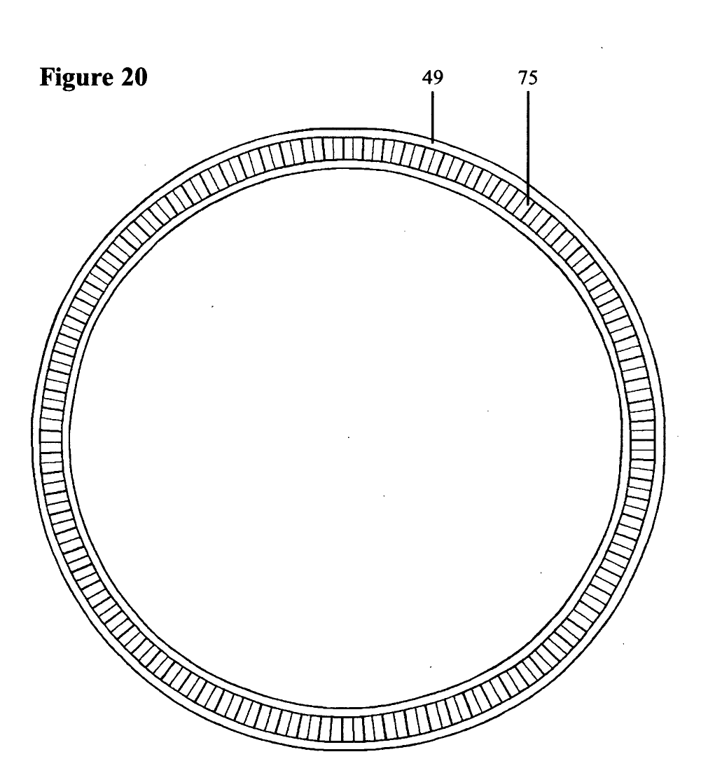

The handle 38 has a release button 98 on the top FIG. 6. The handle 38 is permanently attached to a thin pad 87 with teeth on the bottom. This pad 87 sits inside of a track 94 that both support the pad 87 and allow the pad 87 to easily slide back and forth. When the operator presses down on the handle release button 98, FIG. 6, a ball peen tab 29 is release at the base of the handle 38 just before the pad 87. On the track 94 you will see holes cast into its sides to accommodate this ball peen tab 29. When the tab 29 is released from these holes in the track 94; the handle 38 can be pushed down slightly where it contacts the top of a spur gear 88. The operator will encounter some resistance because of the rods of the spur gear 88 are mounted on a support cast into the inner housing of the saw this support has a spring box 91 attached which acts to hold up the spur gear 88, so the operator would have to push down to engage the ball peen tabs 29 on the handle 38 into a lower opening which spans across the entire track 94 just below the individual ball peen openings see FIG. 15. Now the handle 38 has the freedom to slide back and forth while the spur gears 88 and 89 are engaged with the top of the planetary gear 80 which sits on top of three gears 85 that are attached to the cross members 18 that are brazed into the individual blade housings 1. See also FIG. 2, FIG. 3, and FIG. 15, FIG. 16, and FIG. 17.

There is a flat plate 93 that is attached to the stem of the 89 spur gear protruding from the bottom spring box 91, see also FIG. 15 and FIG. 16. When the spur gears 88 and 89 are lowered this piece 93 pushes down on the brake pad 96 to release the planetary gear 80 so it can be moved back and forth. The brake pad 96 is be attached to a larger spring box 98 of which keeps the brake pad 96 biased naturally in the up position. So when all is released the pad will move back and forth affecting the 88 and 89 spur gears of which will turn the planetary gear 80. The planetary gear 80 will turn the spur gear 85 that is attached to the cross member 18 brazed to the blade 1 so these aforementioned actions pivots the blade 1 up and down, and then brakes the blade 1 once the blade 1 is in position. The brake 3 is bolted to the side of the 80 planetary gear. Also not shown you have a soft foam pad attached to the support contacting a smooth surface to assist the cage 44 in stopping at the right placement for the brake 3 operation. In contrast on the original covert saw which is the industrial version for larger pipe the reciprocating action kept the brake pad 96 and brake 3 in one small area so that this would not be necessary. In the Professional version the cage 44 rotates all the way around 360 degrees.

In another embodiment to this invention we eliminate gears 88 and 89 along with the entire brake set up in FIGS. 10, 16, 18, 19, and we change the surfaces of the planetary gear 80 where we smooth out the top surface and have the teeth on the bottom. The top handle 38 would be mounted on a pivot with an arm that has a pad 7 reaches whose purpose is to release the curtains 25 from the spring 32 (not shown) force to open curtains 25 when desired. Also this spring 32 (not shown) serve as a release for when drop off pipe get caught in curtains 25 causing curtains 25 to open when released from the spring-loaded clip 34,(not shown) to prevent damage to themselves. The curtains 25 are in there own compartment located on both sides of the saw body, cast just inside of the outer body before the vise 53 FIG. 2 on one side.

What is claimed is:

1. A pipe cutting tool comprising:
An outer housing having an opening therein for the insertion of pipe
An external trigger and an external trigger release button
An external handle sitting on top of external saw housing a release button on top of said external handle
An external knob for a jaw assembly with the jaw assembly being adjusted by said external knob both toward and away from pipe being cut
An arrangement of one or more circular saw blades or an abrasive circular disk each within its own housing inside of opening of said saw body
A number of blade housings mounted on a squirrel cage frame, housing circular saw blades or abrasive circular disk said blade housings being penetrated through their body on the end portion opposite said blades so that the blade end pivots on an axis towards and away from pipe
A squirrel cage frame having two tiers
A drum housing casted as a compartment on the inner side of the outer housing
A planetary bevel gear bolted directly to said cage on one side with the opposite side consisting of
An arrangement of individual spur gears or sprockets along the peripheral inner axis attached to stems that pass through said cage frame and also passing through
Spacers arranged to divide said cage from said blade housings while allowing said blade housings to pivot along their own axis
A second planetary bevel gear on the opposite side of said cage where the first said planetary bevel gear is bolted thereto where said second planetary bevel gear floats on top of said spur gears or sprockets and second planetary bevel gear is also bolted to
A planetary inside gear or a cylindrical solid chain of which makes direct contact with and drives said spur gears or sprockets attached to stems on the outside of said squirrel cage frame at the same time penetrating said cage, with said planetary inside gear or said cylindrical solid chain consisting of two flanges bolted to both sides of said planetary inside gear or said cylindrical solid chain to hold said planetary inside gear or cylindrical solid chain on top of spur gears or sprockets floating having said spur gears or sprockets as a support means while at the same time driving the same said spur gears, the same said planetary inside gear or said cylindrical solid chain with flanges bolted to its sides also being bolted to the second beveled planetary gear
A bevel gear of which drives said first beveled planetary gear attached directly to said cage with the same said bevel gear being attached to a stem and passes through the cutting drum wall and is driven by a gear train
A gear train arranged as two separate gear trains being driven in opposite directions by the same main motor drive pinion
A second bevel gear attached to a second stem that passes through the same cutting compartment wall on the opposite side of said cage and drives the second said beveled planetary gear that has a planetary inside gear or cylindrical solid chain bolted concentrically to said second beveled planetary gear
A second planetary inside gear or cylindrical solid chain with flanges bolted to the outer side portions therewith similar to the first aforementioned planetary inside gear or cylindrical solid chain with flanges that work to keep the second planetary inside gear or cylindrical solid chain supported by spur gears mounted on the cross braces that support said blade housing with said spur gears or sprockets being located on the opposite side of the blade housing and close to the center of the outer edge of cage next to the blade housings with the spur gears or sprockets acting to support said second inside gear while at the same time being driven by the same said planetary inside gear or cylindrical solid chain with flanges mounted on the sides thereof while floating on top of spur gears or sprockets attached to the cross braces supporting the blade housings The second planetary inside gear or cylindrical solid chain act to rotate blade housings on an axis towards pipe to be cut
An arrangement of spur gear a pad attached to a handle, a brake pad and a brake arrangement to adjust said blades toward pipe and to keep blade locked in this position spring biased toward the pipe to be cut
A motor that drives a primary pinion mounted on the main motor shaft
An arrangement of curtains that closes around pipe being cut through turning an exterior knob in order to protect user from flying debris.

2. A pipe cutting tool comprising:
An outer housing having an opening therein
An external trigger and an external trigger release button
An external handle sitting on top of external saw housing a release button on top of said external handle
An external knob for a jaw assembly with the jaw assembly being adjusted by said external knob both toward and away from pipe being cut
An arrangement of one or more circular saw blades or an abrasive circular disk each within its own housing inside of opening of said saw body
A number of blade housings mounted on a squirrel cage frame housing circular saw blades or abrasive circular disk said blade housings being penetrated through their body on the end portion opposite said blades so that the blade end pivots on an axis towards and away from pipe
A squirrel cage frame having two tiers
A drum housing casted as a compartment on the inner side of the outer housing
A planetary bevel gear bolted directly to said cage on one side with the opposite side consisting of
An arrangement of individual spur gears or sprockets along the peripheral inner axis attached to stems that pass through said cage frame and also passing through
Spacers arranged to divide said cage from said blade housings while allowing said blade housings to pivot along their own axis
A second planetary bevel gear on the opposite side of said cage where the first said planetary bevel gear is bolted thereto where said second planetary bevel gear floats on top of said spur gears or sprockets and second planetary bevel gear is also bolted to
A planetary inside gear or a cylindrical solid chain of which makes direct contact with and drives said spur gears or sprockets attached to stems on the outside of said squirrel cage frame at the same time penetrating said cage, with said planetary inside gear or said cylindrical solid chain consisting of two flanges bolted to both sides of said planetary inside gear or said cylindrical solid chain to hold said planetary inside gear or cylindrical solid chain on top of spur gears floating having said spur gears or sprockets as a support means while at the same time driving the same said spur gears or sprockets, the same said planetary inside gear or said cylindrical solid chain with flanges bolted to its sides also being bolted to the second beveled planetary gear
A bevel gear of which drives said first beveled planetary gear attached directly to said cage with the same said bevel gear being attached to a stem and passing through the cutting drum wall also driven by a gear train
A gear train arranged as two separate gear trains being driven in opposite directions by the same main motor drive pinion
A second bevel gear attached to a second stem that passes through the same cutting compartment wall on the opposite side of said cage and drives the second said beveled planetary gear that has a planetary inside gear or cylindrical solid chain bolted concentrically to said second beveled planetary gear
A second planetary inside gear or cylindrical solid chain with flanges bolted to the outer side portions therewith similar to the first aforementioned planetary inside gear or cylindrical solid chain with flanges that work to keep the second planetary inside gear or cylindrical solid chain supported by spur gears or sprockets mounted on the stems that support said blade housing with said spur gears being located on the opposite side of the blade housing and close to the center of the outer edge of cage next to said blade housings with said spur gears or sprockets acting to support said second inside gear or cylindrical solid chain while at the same time being driven by the same said planetary inside gear or cylindrical solid chain with flanges mounted on the sides thereof while floating on top of spur gears or sprockets attached to the cross braces supporting the blade housings The second planetary inside gear or cylindrical solid chain act to rotate blade housings on an axis towards pipe to be cut on the outer side of planetary inside gear or cylindrical solid chain opposite the inner teeth with the outer surface being smooth in the embodiment where a brake section is not used or in the alternate embodiment having teeth when using a brake section and having the capability to adjust the latter being the best mode because of the simplicity and lack of an additional gear train
A motor that drives a primary pinion mounted on the main motor shaft
An arrangement of curtains that closes around pipe being cut through turning an exterior knob in order to protect user from flying debris.

3. A pipe cutting tool of claim 1 consisting of
An outer housing and within said housing a cutting compartment, a gear train compartment, a motor compartment, a jaw assembly compartment, a saw curtain compartment.

4. A pipe cutting tool of claim 1 consisting of one or more circular saw blades or abrasive disk arranged in separate housings.

5. A pipe cutting tool of claim 1 consisting of a caged frame having two tiers.

6. A pipe cutting tool of claim 1 consisting of a cutting drum housing.

7. A pipe cutting tool of claim 1 consisting of a beveled planetary gear bolted to said cage for the purpose of rotating said cage.

8. A pipe cutting tool of claim 1 consisting of a jaw assembly to hold pipe being cut in place.

9. A pipe cutting tool of claim 1 comprising a second said beveled planetary gear, going in the opposite direction as the first said beveled planetary gear with said planetary bevel gear being bolted to said planetary inside gear or cylindrical solid chain that is both floating on top of and driving individual spur gears or sprockets as one.

10. A pipe cutting tool of claim 1 comprising
spur gears or sprockets on the outer side of squirrel cage on,
cross braces that protrudes through said cage body and through said spacers into said blade housing where it is attached therewith
a second said spur gear or sprocket inside of blade housing being concentrically connected to first said spur gear by said cross member going through said spacer.

11. A pipe cutting tool of claim 1 where
a fourth planetary gear with teeth being casted on the side of such said planetary gear with said planetary gear or solid cylindrical chain floating on top of spur gears or sprockets that are directly casted into the main body of jaw assembly.

12. A pipe cutting tool of claim 1 where said gear train has two sections where said gear train sections are driven by the main pinion drive in opposite directions.

13. A pipe cutting tool of claim 1 consisting of an outer housing.

14. A pipe cutting tool of claim 3 consisting of an outer housing, a cutting compartment drum, a motor compartment, a gear train compartment with a wall that separates gear train from debris and shavings, a jaw assembly compartment, an exterior curtain compartment that protects user from flying debris.

15. A pipe cutting tool of claim 3 consisting of said outer housing with a hinged trap door an the bottom of said outer housing for disposing debris and shavings.

16. A pipe cutting tool of claim 3 with an inner drum housing consisting of track rails for the said cage to rotate on.

17. A pipe cutting tool of claim 3 having a jaw assembly compartment with a metal plate attached to inner jaw bodies to protect saw body from the stress and pressure of the jaw assembly while holding the pipe being cut to prevent fracture of the outer body frame.

18. A pipe cutting tool of claim 4 having one or more circular saw blade or abrasive disk arranged in separate houses.

19. A pipe cutting tool of claim 4 having one or more saw blade housings consisting of a spur gear or a sprocket on the upper ends of blade housing with a chain or belt attached thereto and also a smaller pinion gear or sprocket attached directly to said blade or abrasive disk with other end of said chain of belt attached thereto in order to turn said saw blade or abrasive disk.

20. A pipe cutting tool of claim 5 consisting of a said two tier cage frame where said blade housings are mounted therewith, with one tier supporting said blade housings, with the second tier supporting wheels that said cage will rotate on in its entirety.

21. A pipe cutting tool of claim 6 consisting of a cutting drum housing having tracks or rails for said cage to rotate on.

22. A pipe cutting tool of claim 8 consisting of a jaw assembly to hold pipe in place during the cutting process.

23. A pipe cutting tool of claim 8 consisting of a jaw assembly consisting of
a vise body,
a tube casted onto said vise body,
a flat bed with,
a vise shoe made of a ridged pad that will make contact with the pipe with
a second hollowed tube attached, with this second hollowed tube being casted with an inner helix trench therewith,
a solid tube having a said spur gear bolted to it; this said solid tube casted with
a helix track to ride inside of said helix trench on the second said hollowed tube when the said bolted spur gear is turned by the said fourth planetary gear with the teeth mounted on the side of said planetary gear,
also said jaw assembly consisting of
a vise dress shaped in an A frame with an accordion fold.

24. A pipe cutting tool of claim 9 consisting of said second beveled planetary gear that is bolted to the side of an inside gear that has flanges bolted to the side of the said inside gear.

25. A pipe cutting tool of claim 9 consisting of said planetary inside gear or cylindrical solid chain bolted to said planetary beveled gear being axially concentric with said planetary inside gear or cylindrical solid chain consisting of flanges bolted on both sides that wrap around said spur gears or sprockets that are attached to cross braces protruding through the said cage bars and into said blade housings so that said planetary inside gear or cylindrical solid chain with flanges is floating so that the spur gears or sprockets that it drives also supports said planetary inside gear or cylindrical solid chain that is bolted to said second planetary beveled gear.

26. A pipe cutting tool of claim 11 consisting of
a fifth planetary gear with the teeth being casted on the side of said fifth planetary gear, said planetary gear or cylindrical solid chain will drive said spur gears or sprockets casted to the jaw assembly for adjusting said jaw assembly both toward and away from pipe being cut, said fifth planetary gear or cylindrical solid chain is located in the jaw assembly compartment.

27. A pipe cutting tool of claim 12 consisting of
two sets of gear trains attached to the main pinion motor drive with each said gear train being rotated in opposite directions to turn said cage in one direction and said cutting blades in the opposite direction inducing more speed from said blades and reducing wear because of this movement and increasing the cutting power.

28. A pipe cutting tool of claim 1 consisting of two sets of,
curtains on opposite sides of openings of said cutting drum compartment, said curtains opens and closes by turning,
a combination knob on the outer body that protrudes through saw body and is manifested as,
two knobs attached to each other through a rod with each knob on opposite sides of saw body, both knobs being attached to their own respective,
gear train on each side of said external saw body; each individual gear train will turn,
a ring mounted around said drum opening, said ring will be bolted to individual,
overlapping blades shaped like teardrops, one section of said ring will comprise,
a short gearing or sprocket section each individual tear drop shaped blade will be bolted to said housing so that when said ring is turned by said gear train and said tear drop shaped blades will open in unison each with there own individual axis, said rings will be attached individually to,
springs and biased toward the direction of the opening, said rings being positioned where if the rings are thrown off track or moved substantially in any direction transverse to the direction of rotation as in a scenario where the pipe being cut falls off and said curtains will open before being damaged by drop off pipe.

29. A ridged pad attached to said pipe adjustment handle, with said pad sitting inside of,
a cradle support just underneath the handle opening attached to said cradle will be,
two supports members holding,
two wide spur gears between said supports on the outside of said supports you have,
two spring boxes attached to the stems of said spur gears through said supports, said spring boxes are biased up toward the top of saw to keep said spur gears suspended above fourth planetary inside gear of which in this embodiment not being best mode but the original configuration brought forth, said inside gear in this embodiment also having a sixth planetary gear bolted to the top surface back to back inside teeth and outside teeth therewith.

30. A pipe cutting tool comprising:
A process where you have plural blades that are engaged with a motor and rotates through pinions, gears, chains, the rotating blades being mounted on a cage that is rotated in the opposite direction by the same said motor where the blades are in constant motion on two planes inducing faster cutting and less blade wear.
